(19) United States
(12) Patent Application Publication
(10) Pub. No.: US 2014/0110378 A1
(43) Pub. Date: Apr. 24, 2014

(54) GAS CIRCUIT BREAKER MULTI-PIECE TANK

(71) Applicant: MITSUBISHI ELECTRIC POWER PRODUCTS, INC., Cypress, CA (US)

(72) Inventors: Russell N. Yeckley, Murrysville, PA (US); Paul J. Vladuchick, Seven Fields, PA (US); Dennis J. Matuszak, Seven Fields, PA (US)

(73) Assignee: MITSUBISHI ELECTRIC POWER PRODUCTS, INC., Cypress, CA (US)

(21) Appl. No.: 13/758,794

(22) Filed: Feb. 4, 2013

Related U.S. Application Data
(60) Provisional application No. 61/716,414, filed on Oct. 19, 2012.

(51) Int. Cl. H01H 33/53

(52) U.S. Cl. CPC H01H 33/53
USPC 218/155

(57) ABSTRACT

A multi-segment tank for high voltage gas circuit breakers such as, e.g., 800 kV gas circuit breakers. The tank includes two or more segments. In a three segment embodiment, the tank includes a short or compact center segment fabricated to mount an interrupter device and support the interrupter's operating linkage, while two end segments are connected with flange joints to surround the remainder of the interrupting device. Alternatively, a tank is provided that is constructed in two segments.

### CROSS-REFERENCE TO RELATED APPLICATION

This application claims benefit under U.S.C. §119(e) from U.S. Provisional Patent Application No. 61/716,414, filed on Oct. 19, 2012, the entirety of which is incorporated by reference herein.

### FIELD

The embodiments described herein relate generally to gas circuit breakers and, more particularly, to systems and methods that facilitate the assembly of high voltage gas circuit breakers.

### BACKGROUND INFORMATION

The arrangement of a typical dead tank high voltage gas circuit breaker includes a metallic tank that encloses a mechanical interrupting device which opens the current path in an electric power transmission system. The space around the interrupter is filled with a pressurized insulating gas, making the tank function as a pressure-containing vessel.

Construction of a gas circuit breaker typically involves inserting a semi-complete interrupter through the tank end(s) (See FIG. 1) and then performing operations inside the tank to complete the assembly. In high voltage gas circuit breakers, such as, e.g., an 800 kV gas circuit breaker, the large circuit breaker and long tank length usually makes it necessary for multiple openings in the tank or one or more workers to enter the tank, i.e., insert their entire body or a substantial portion of their body into the tank, to secure the interrupter, connect operating linkages, and complete miscellaneous assembly steps.

Thus, it is desirable to provide improved systems and methods that reduce or eliminate the need for multiple tank openings and to perform work in the space enclosed by a circuit breaker tank to secure the interrupter, connect operating linkages, and complete miscellaneous assembly steps.

### SUMMARY

The embodiments provided herein are directed to systems and methods that facilitate the assembly of high voltage gas circuit breakers such as, e.g., 800 kV gas circuit breakers. To reduce or eliminate the need for a tank with multiple openings and to perform work in the space enclosed by a tank surrounding an interrupter of the circuit breaker, a tank is provided that is constructed in three segments. A short or compact center segment is fabricated to mount the interrupter and support the operating linkage, while two end sections are connected to the center segment with flange joints to surround the remainder of the interrupter device.

With this enhancement, assembly of the interrupter can take place within the center segment before the end segments are attached. The compact size and open ends of the center segment allow workers to perform assembly operations without placing significant portions of their bodies inside the tank. With convenient access to the center segment, the ability to clean and inspect is improved and, thus, the possible accumulation of dirt and particles is eliminated or significantly reduced.

The configuration and physical shape of the bolted flanges offers the added benefit of providing an area that traps foreign particles and contaminants that would harm the equipment if otherwise allowed to migrate freely.

Alternatively, a tank is provided that is constructed in two segments.

Other systems, methods, features and advantages of the example embodiments will be or will become apparent to one with skill in the art upon examination of the following figures and detailed description.

### BRIEF DESCRIPTION OF THE FIGURES

The details of the example embodiments, including fabrication, structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a perspective view of a tank of a conventional gas circuit breaker housing an interrupter device.

FIG. 2 is a perspective view of an embodiment of a gas circuit breaker device having a three piece tank housing an interrupter device.

FIG. 3 is a sectional view of the central segment of the three piece tank in FIG. 2 housing an interrupter device.

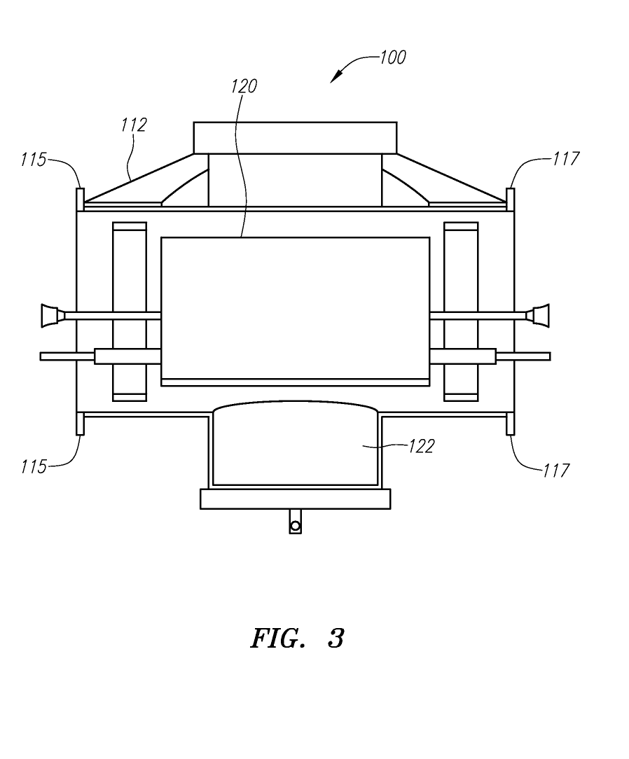

FIG. 4 is a perspective view of an embodiment of a gas circuit breaker device having a two piece tank housing an interrupter device.

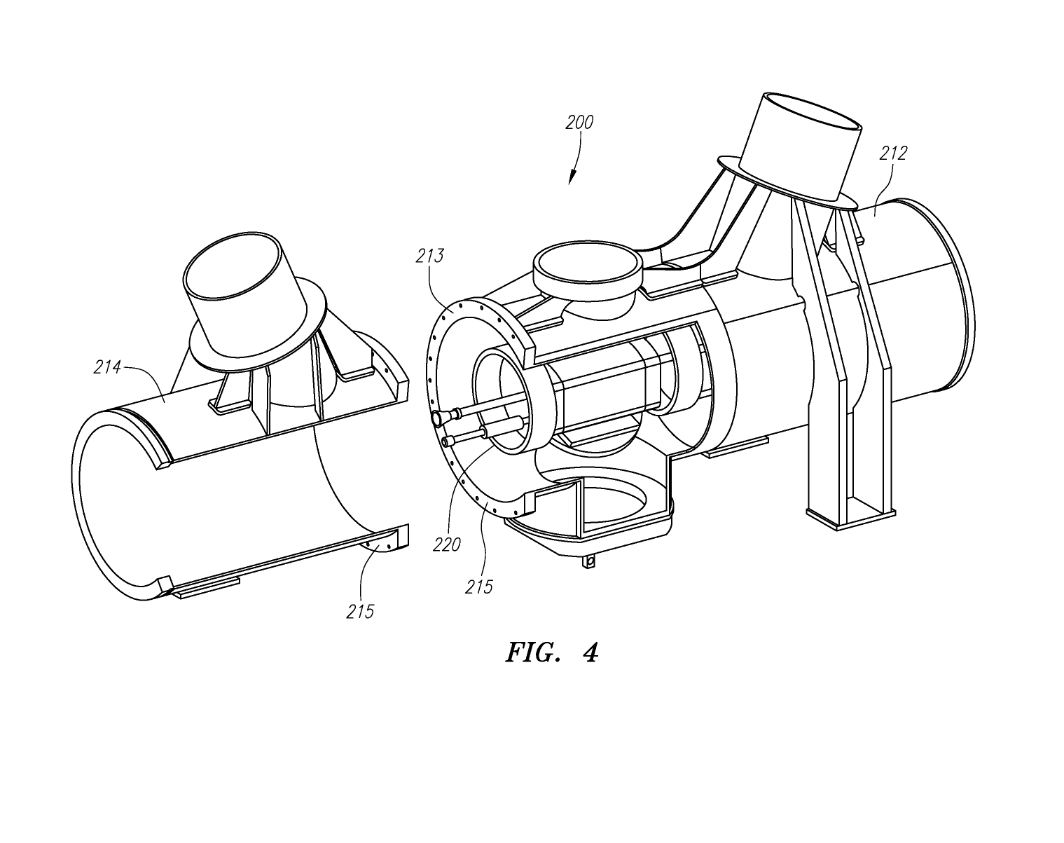

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

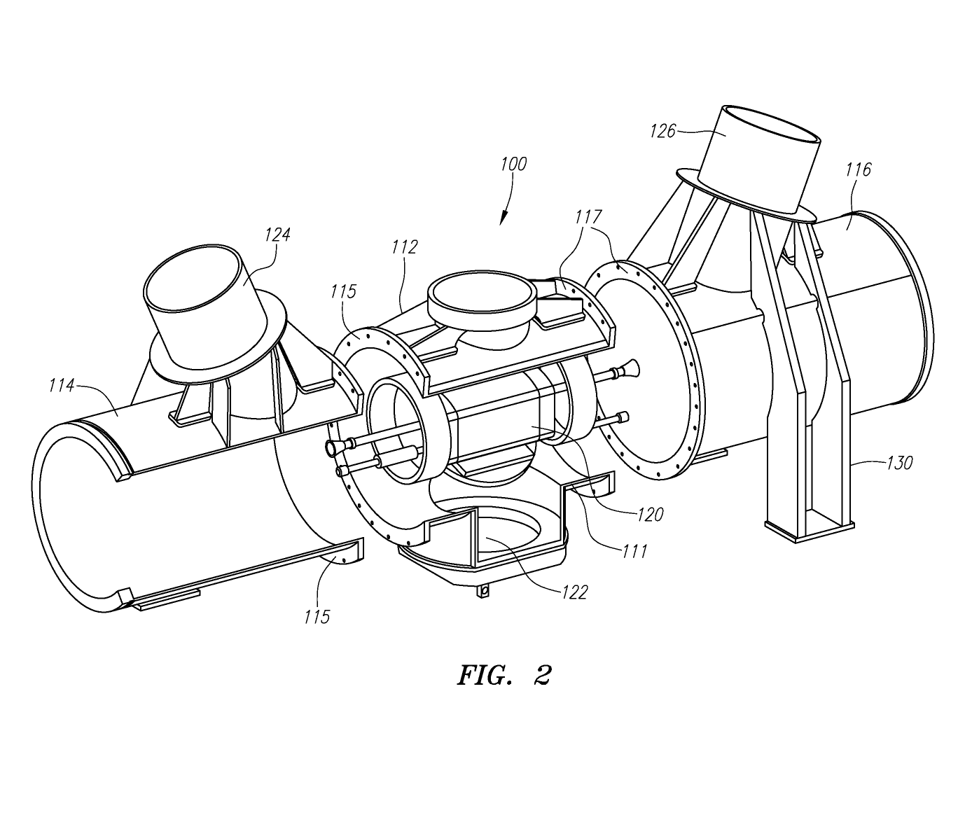

The embodiments described herein are directed to systems and methods that facilitate the assembly of high voltage gas circuit breakers such as, e.g., 800 kV gas circuit breakers. To reduce or eliminate the need to perform work in a space enclosed by a tank enclosing an interrupter of the circuit breaker, this disclosure describes a tank that is constructed in three segments. As depicted in FIG. 2, a multi-piece tank 100 of a gas circuit breaker is shown to include a short or compact center segment 112 that is fabricated to mount an interrupter and support the operating linkage of an interrupter device 120 on a mount 122 disposed in the center segment 112. The tank 100 further includes two end segments 114 and 116 that are connected to the center segment 112 with flange joints 115 and 117 to surround the remainder of the interrupter device 120.

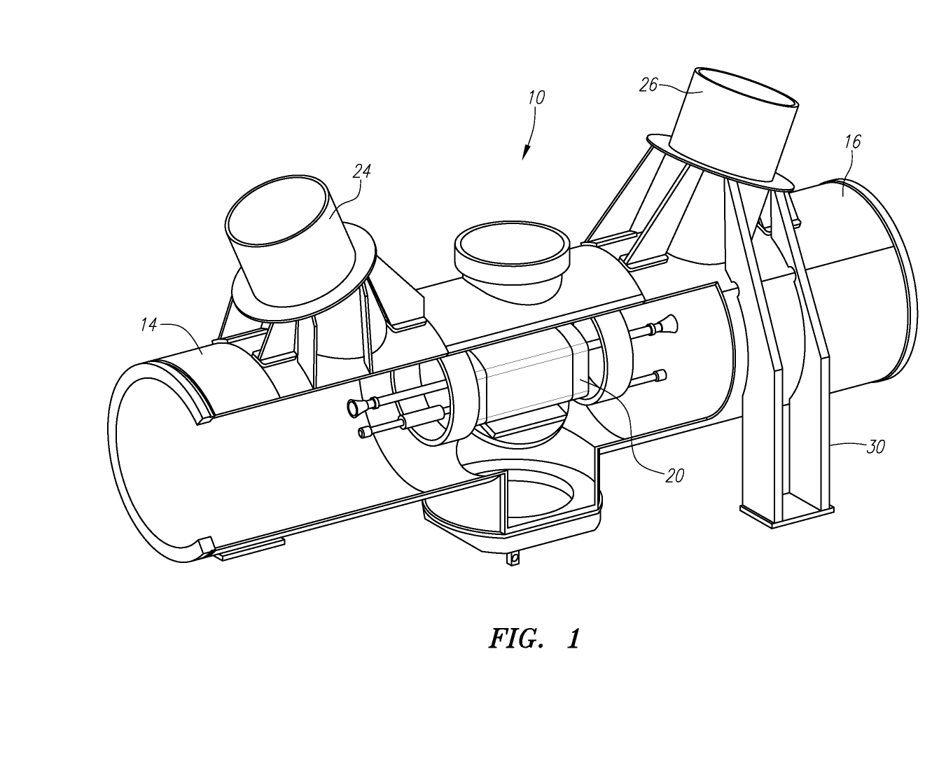

The center segment 112 and two end segments 114 and 116 of the multi-piece tank 100 are assembled to form a single tank or pressure vessel similar to the conventional tank 10 of unitary construction shown in FIG. 1. The conventional tank 10, which is supported by a frame 30 of galvanized steel, houses an interrupter device 20 and is configured to support two bushing units couplable to two bushing ports 24 and 26 extending from the tank 10 at opposite ends of the tank 10. As shown in FIG. 2, the multi-piece tank 100 houses an interrupter device 120 and is configured to support two bushing units couplable to two bushing ports 124 and 126 extending from each of the end segments 114 and 116 adjacent opposite ends of the tank 100. The multi-piece tank is also supported by a frame 130 of galvanized steel.

With the enhancement of a multi-piece tank 100, assembly of the interrupter device 120 can occur within the center segment 112 of the tank 100 before the end segments 114 and 116 are attached to the center segment 112. The compact size and open ends of the center segment 112 enable workers to perform assembly operations, such as, e.g., mounting of the interrupter device 120, connecting operating linkages, and miscellaneous finishing operations without placing significant portions of their bodies inside the tank 100, i.e., place their bodies into what would otherwise be a significantly confining work space within the tank 100. This eliminates and/or minimizes the need for a) access ports in the tank walls 111, b) workers entering a long narrow tank 100, and/or c) complex tools to remotely perform assembly operations from outside the tank 100.

The end segments 114 and 116 of the tank 100 are added to enclose the interrupter device 120 within the tank 100 after internal mountings, assembly, and/or adjustments are complete.

Completion of the assembly of the interrupter device 120 prior to enclosing it with the tank end segments 114 and 116 a) minimizes the likelihood that foreign particles or contamination will be introduced during the assembly process, and b) facilitates the detection and removal of any contamination that may be present within the tank 100.

Because only a compact portion of the total tank 100 is present during insertion and finishing of the interrupter device 120, there is far less impingement on factory space, efficiency, and overall throughput than typically occurs during construction of a high voltage gas circuit breaker in the range of about 800 kV.

The configuration and physical shape of the bolted flanges 115 and 117 offers the added benefit of providing an area that traps foreign particles and contaminants that would harm the equipment if otherwise allowed to migrate freely. The flanges 115 and 117 of the separate tank segments 114 and 116 are configured to trap foreign particles and contaminants using methods, features, and /or geometries disclosed in U.S. patent application Publication No. 2011/0226503, which application is incorporated by reference.

In an alternative embodiment, one of the flange joints of the three-piece tank embodiment 100 is eliminated to create a two-piece tank 200. The two-piece tank 200 includes a first segment 212 with an open end adjacent a central region 213 housing an interrupter device 220. A second segment 214 is couplable with flange joints 215 to the first segment to surround the interrupting device 220.

The benefits of eliminating a joint include reduced tank cost, fabrication complexity, and potential for gas leakage. The manufacturing time to assemble the second joint is also eliminated. Although having open access to the interrupter device 220 from only one end of the first segment 212 decreases assembly flexibility, the associated consequences are negligible compared to the benefits.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A gas circuit breaker comprising a multi-piece tank having a compact center segment and first and second end segments, and an interrupter device mounted in the center segment of the tank.

2. The circuit breaker of claim 1 wherein the center segment is open at first and second ends and, prior to coupling to the first and second end segments, provides access to the interrupter device without requiring an assembler to place significant portions of the assembler's body inside the tank.

3. The circuit breaker of claim 2 wherein the center segment is couplable to the first and second segments with first and second flange joints.

4. The circuit breaker of claim 3 wherein the flange joints are configured to trap foreign particles and contaminants.

5. The circuit breaker of claim 1 wherein the first and second end segments include first and second bushing ports.

6. The circuit breaker of claim 5 wherein the first and second bushing ports are positioned extending at an angle away from the center segment.

7. The circuit breaker of claim 5 wherein the first and second bushing ports are positioned extending perpendicularly.

8. A gas circuit breaker comprising
a multi-piece tank having first and second segments, and
an interrupter device mounted in the first segment of the tank, wherein the first segment having an opening at a first end and, prior to coupling to the first and second segments, the opening providing access to the interrupter device without requiring an assembler to place significant portions of their body inside the tank.

9. The circuit breaker of claim 8 wherein the first and second segments are couplable together with a flange joint.

10. The circuit breaker of claim 9 wherein the flange joint is configured to trap foreign particles and contaminants.

11. The circuit breaker of claim 8 wherein the first and second segments include first and second bushing ports.

12. The circuit breaker of claim 11 wherein the first and second bushing ports are extending at an angle away from a central region of the tank.

13. The circuit breaker of claim 11 wherein the first and second bushing ports are positioned extending perpendicularly.

14. A gas circuit breaker comprising
a multi-piece tank having two or more segments, and
an interrupter device mounted in one of the two or more segments of the tank, wherein the one of the two or more segments housing the interrupter having an opening at a first end and, prior to coupling the two or more segments together, the opening providing access to the interrupter device without requiring an assembler to place significant portions of their body inside the tank.

15. The circuit breaker of claim 14 wherein the two or more segments comprise a compact center segment and first and second end segments.

16. The circuit breaker of claim 15 wherein the interrupter device is mounted in the center segment of the tank.

17. The circuit breaker of claim 16 wherein the center segment is open at first and second ends adjacent the interrupter device.

18. The circuit breaker of claim 14 wherein the two or more segments are couplable together with at least one flange joint.

19. The circuit breaker of claim 18 wherein the at least one flange joint is configured to trap foreign particles and contaminants.

20. The circuit breaker of claim 14 wherein the two or more segments include first and second bushing ports.
